(19) United States
(12) Patent Application Publication
(10) Pub. No.: US 2017/0098243 A1
(43) Pub. Date: Apr. 6, 2017

(54) SYSTEMS AND METHODS FOR EXHIBITION DATE NOTIFICATION

(71) Applicant: Disney Enterprises, Inc., Burbank, CA (US)

(72) Inventor: SUSAN CICCHINO, Toluca Lake, CA (US)

(73) Assignee: DISNEY ENTERPRISES, INC., Burbank, CA (US)

(21) Appl. No.: 14/873,057

(22) Filed: Oct. 1, 2015

(51) Int. Cl. G06Q 30/02; H04L 29/08

(52) U.S. Cl. CPC G06Q 30/0258; H04L 67/16

(57) ABSTRACT

Systems and methods for exhibition date notification are provided. A user may specify a particular genre of entertainment and/or a particular entertainment provider. Through the use of an exhibition date notification application, the user can further specify notification controls and/or preferences so that the user will be notified of upcoming exhibition dates associated with entertainments commensurate with the specified entertainment genre and/or provided by the specified entertainment provider.

### TECHNICAL FIELD

The present disclosure relates generally to exhibition date notification.

### DESCRIPTION OF THE RELATED ART

With the proliferation of media content types and entertainment exhibitions, and the manner in which media content and entertainment exhibitions can be consumed and/or experienced, consumers are often unaware of when such media content becomes available for consumption or purchase, or when consumers can attend entertainment exhibitions. For example, movies may have a theatrical release, an on-demand video release, a DVD release, etc. Entertainment exhibitions may be attended live or may be consumed via online streaming.

Moreover, the rise of the Internet has led to an increase in the popularity of shopping and purchasing over the Internet. However, online purchasing of media content or tickets to events are often limited with respect to online purchase venues. For example, in order to purchase a ticket to attend an event, such as a concert, consumers must purchase the ticket at an online ticket distributor. Likewise, in order to purchase digital media content, consumers must access the transaction portal of a particular digital media content distributor.

### BRIEF SUMMARY OF THE DISCLOSURE

According to various embodiments of the disclosed systems and methods, a user may easily and efficiently specify media contents or events that the user wishes to be notified about based on a particular studio or genre. Moreover, the user can access preview media content, as well as purchase the media content for consumption, purchase tickets to an event(s), etc.

In accordance with one embodiment, a method comprises receiving from a user, an indication of at least one of an entertainment distributor and genre of entertainment. The method further comprises transmitting to the user, at least one electronic notification associated with an exhibition of one or more entertainments provided by the entertainment distributor or commensurate with the genre of entertainment.

In accordance with another embodiment, an apparatus comprises a processor, and a memory having computer code. The computer code causes the processor to receive from a user, an indication of at least one of an entertainment distributor and genre of entertainment. The computer code further causes the processor to transmit to the user, at least one electronic notification associated with an exhibition of one or more entertainments provided by the entertainment distributor or commensurate with the genre of entertainment.

In accordance with yet another embodiment, a computer-implemented method comprises receiving information indicative of at least one of a media content distributor and genre of media content. Additionally, the computer-implemented method comprises retrieving information regarding at least one release date associated with a media content provided by the media content distributor or commensurate with the indicated genre of media content. Further still, the computer-implemented method comprises presenting, to a user, an electronic alert informing the user of the at least one release date based upon a predetermined amount of time preceding the at least one release date or reminding the user that the at least one release date has passed.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments of the disclosure.

FIG. 1 illustrates a high-level block diagram of an example system for exhibition date notification in accordance with the present disclosure.

FIG. 2 is an operational flow diagram illustrating an example exhibition date notification process flow that may be performed in accordance with the present disclosure.

FIGS. 3A-3J illustrate example user interface aspects of an exhibition date notification application in accordance with the present disclosure.

FIG. 4 illustrates an example computing component that may be used to implement various features of the methods disclosed herein.

The figures are not exhaustive and do not limit the disclosure to the precise form disclosed.

### DETAILED DESCRIPTION

Consistent with embodiments of the present disclosure, computerized systems and methods are provided for exhibition date notification associated with entertainment. As used herein, the term “entertainment” can refer to any recreational, educational, interactive, or other activity of interest to one or more users. Examples of entertainment includes movies, concerts, dances, theatre, art shows, museum exhibits, sporting events, theme parks, book readings, lectures, and the like. An entertainment may have one or more exhibitions. In the present disclosure, the terms “exhibition,” “show,” “showing,” “event,” and “performance” may be used interchangeably and should not be deemed to limit the scope or applicability of various embodiments. An exhibition date can refer to a date and/or time associated with the release or presentation of entertainment. As used herein, the term “media” or “media content” can refer to movies, short-form digital media content, long-form digital media content, video games, online games, podcasts, TV content, etc., which themselves may be a form of entertainment.

Embodiments of the present disclosure allow a user to be notified of an exhibition date and/or time at which entertainment will become available for consumption or an exhibition may be attended. Through the use of an exhibition date notification application, a user may select one or more entertainments of interest by selecting a genre of entertainment or an entertainment distribution entity, such as a studio or entertainment distributor. It should be noted that genre can refer to both a type of a particular entertainment form, for example, jazz music, rock music, salsa music, as well as the entertainment form itself, such as music, film, theater, etc. Notifications can be sent to a user via a plurality of different mechanisms, all of which may be configured or tailored to the user's preferences. These may include social media, text, email, etc. Upon the receipt of such notifications, the user may be given the option to purchase and/or pre-order tickets or exhibition licenses, digital versions of media content, view a preview of the entertainment, and the like.

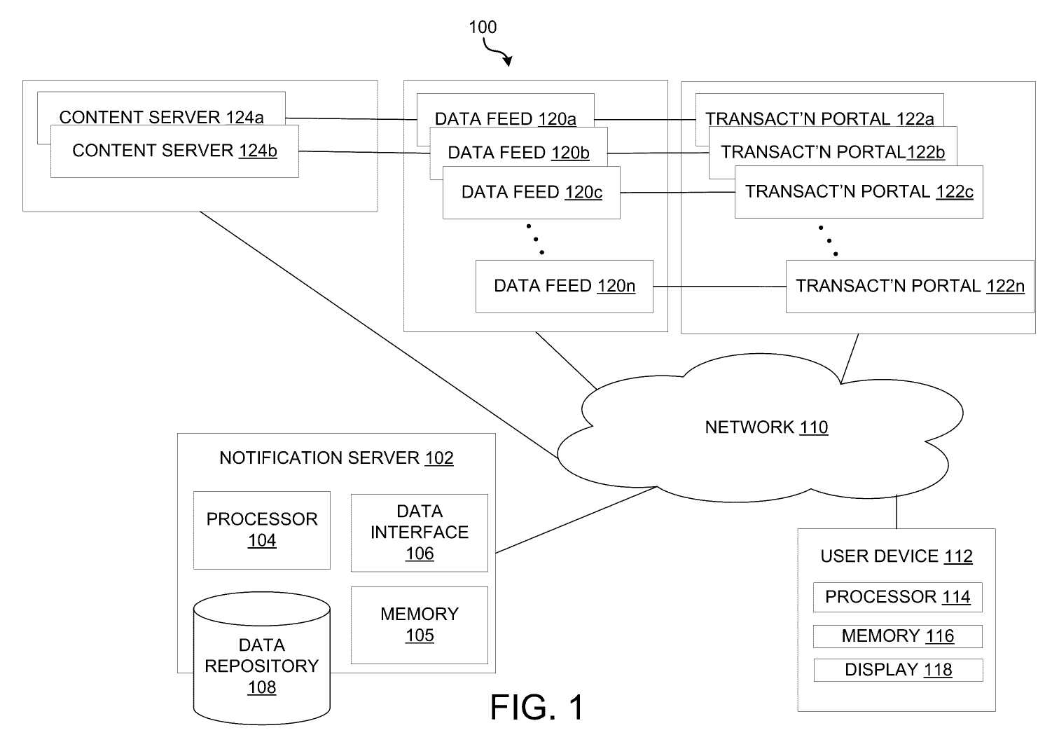

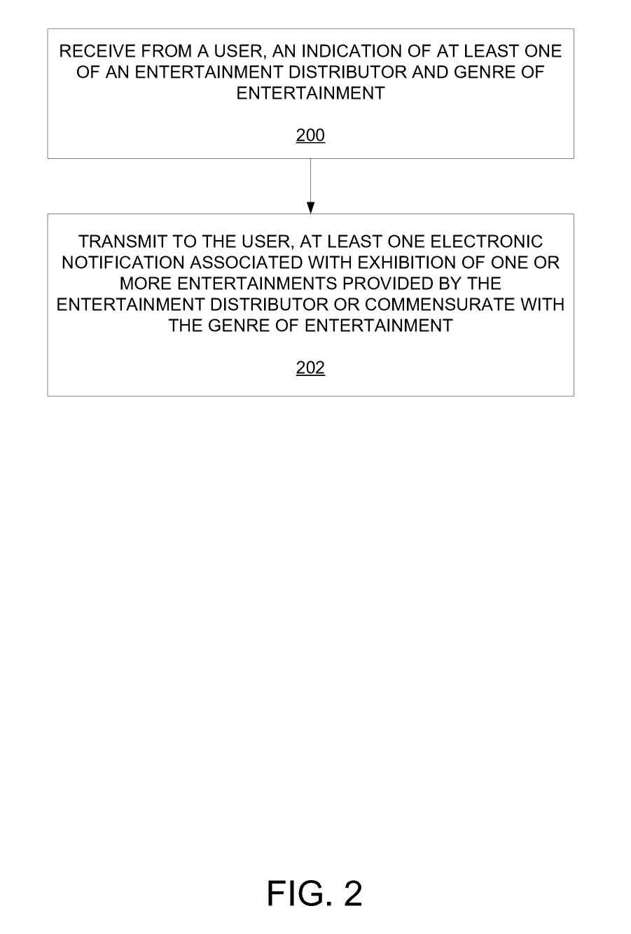

FIG. 1 illustrates a high-level block diagram of an example system 100 for exhibition date notification in accordance with the present disclosure. As illustrated in system 100, a notification server 102 may include a processor 104, a memory 105, and optionally, a data interface 106. Processor 104 operates in accordance with computer program code stored in memory 105 configured to cause processor 104 to transmit exhibition notification information and/or entertainment and exhibition data (discussed below) to user device 112 for generating exhibition notification data. Processor 104 is also connected to data repository 108. Data interface 106 may receive exhibition and entertainment data from one or more data feeds 120a-120n. FIG. 2 is an operational flow diagram illustrating an example exhibition release date notification process flow that may be performed in accordance with the present disclosure, and will be discussed in conjunction with FIG. 1.

In operation, notification server 102 receives data from the various data sources in system 100 (data feeds 120a-120n). The received data may be filtered, mapped, and/or otherwise processed in accordance with data importation rules prior to processing by processor 104 or storage in data repository 108. For example, as described below, a data interface 106 may be provided to filter and map data from data feeds 120a-120n. Such processing may normalize the data, eliminate duplicates in the data, and catch exceptions or errors.

User device 112 may include a processor 114, and a memory 116 containing computer code causing the processor 114 to execute one or more features of an exhibition date notification application described below. A display 118 can display a notification or alert to a user of user device 112. The notification or alert can reflect an upcoming exhibition date or reminder of a past exhibition date associated with the exhibition of some entertainment.

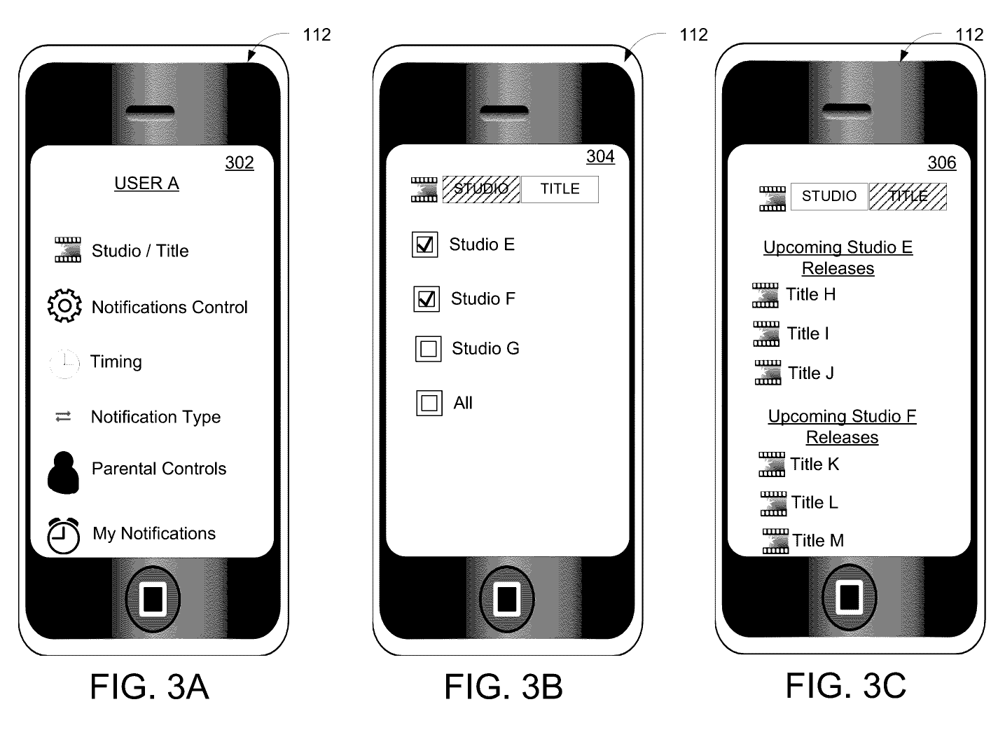

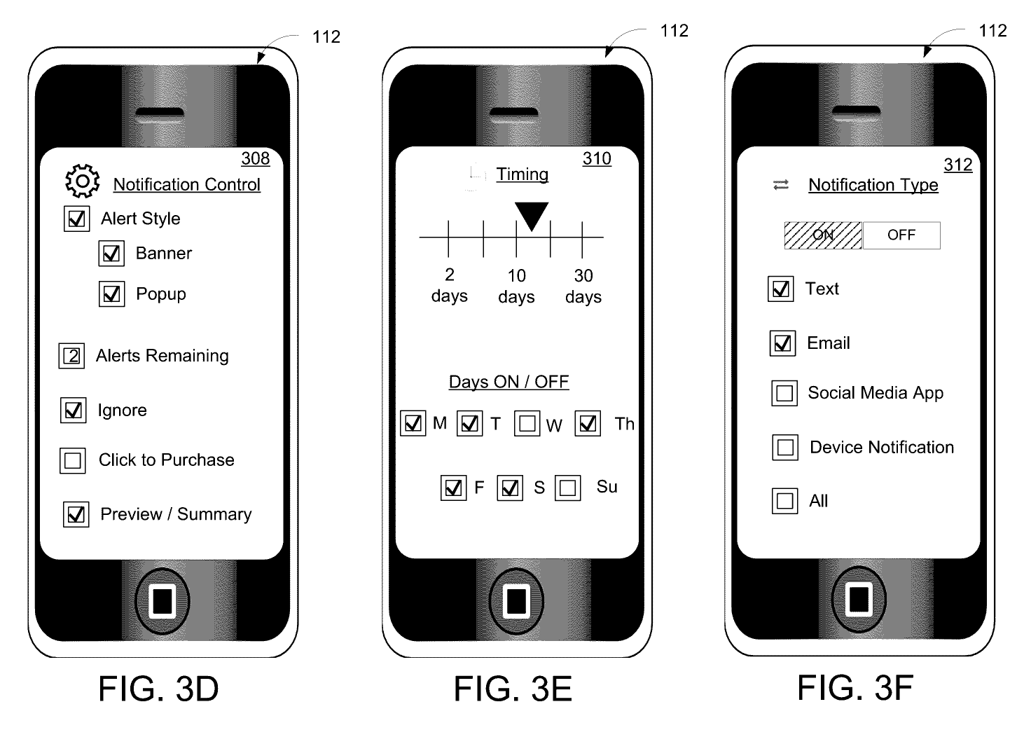

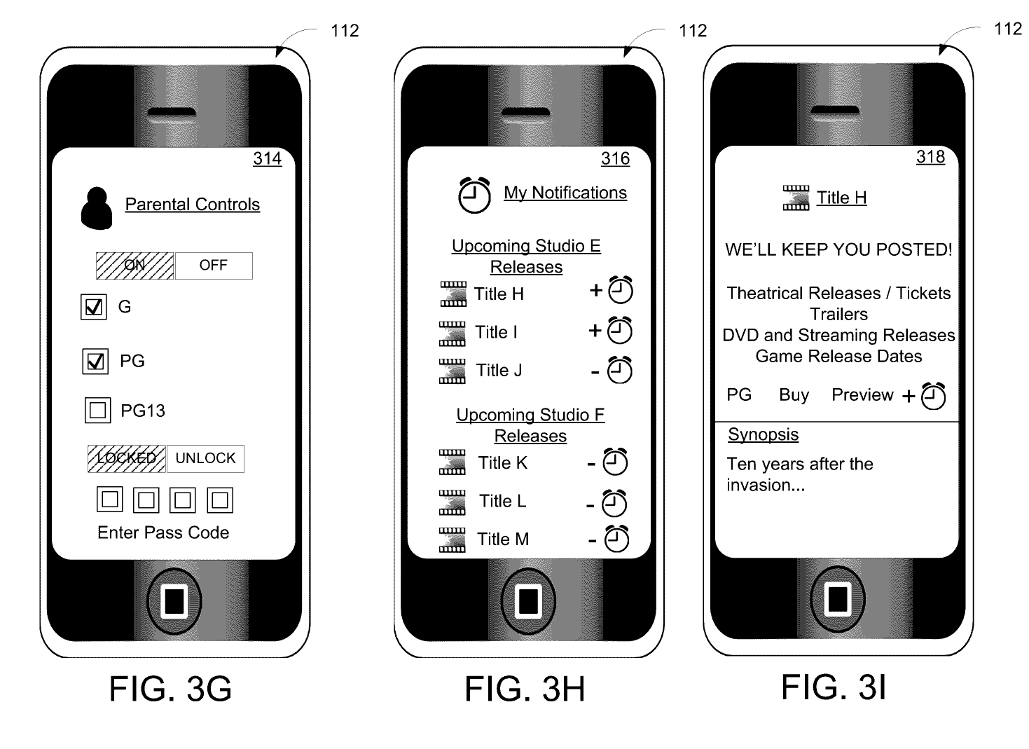

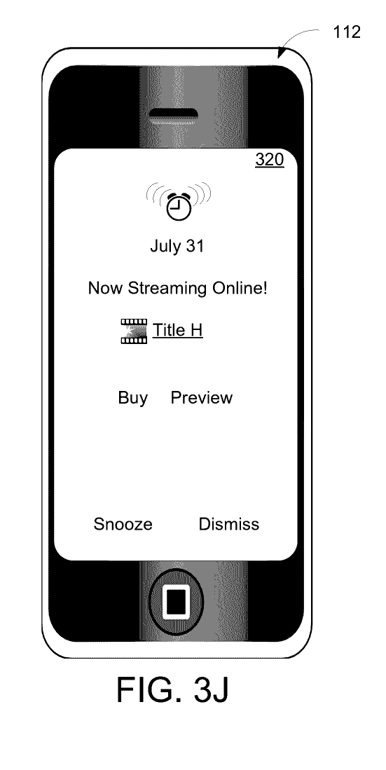

Referring to operation 200 of FIG. 2, processor 104 may receive, from a user, an indication of an entertainment distributor and/or genre of entertainment (as will be explored in greater detail below with respect to FIGS. 3A-3H). Processor 104 may access data repository 108 to retrieve relevant exhibition and entertainment data. At operation 202, processor 104 may transmit, to the user, at least one electronic notification associated with the exhibition of the one or more entertainments provided by the entertainment distributor or commensurate with the genre of entertainment, resulting in the display of the aforementioned notification or alert on user device 112.

Data feeds 120a-120n may be exhibition data feeds and/or entertainment data feeds. Exhibition data feeds 120a-120n may serve as data sources for providing exhibition data for one or more entertainments. The exhibition data may include entertainment identification information, exhibition location, exhibition time, release date and/or time information, and other data pertaining to an exhibition. The exhibition data from data feeds 120a-120n may be sent on a frequent or periodic basis (e.g., daily) to notification server 100. In one embodiment, exhibition data feeds are sent on a daily basis to provide entertainment exhibition data and/or other updates at the end of a business day or during the evening. In another embodiment, position data feeds are sent hourly, substantially simultaneously, or in real-time (for example, upon receipt of a user request). All exhibition data provided by data feeds 120a-120n may be stored in data repository 108 or operated upon in real-time.

Entertainment data provided by data feeds 120a-120n provide entertainment data such as entertainment identification information, entertainment type and/or genre, entertainment rating (e.g., “G”, “PG”, “PG-13”, “R”), entertainment price, entertainment branding information or previews, media clips, background, special characters, or any other data or information that is desired to be included in the entertainment data. Data from entertainment data feeds 120a-120n may be stored in data repository 108 or operated upon in real-time, and used by processor 104 to provide users with information, such as release date information associated with the entertainment. It should be noted that entertainment data and exhibition data can originate from the same data feed.

Entertainment and exhibition data feeds can be embodied by, for example, media content producers, studios, distribution entities, entertainment venues or distributors, ticketing agencies, and/or other entertainment or exhibition data repositories. It should be noted that one or more of data feeds 120a-120n can be associated with respective transaction portals 122a-122n for effectuating the purchase of tickets, licenses, and/or other mechanisms for consuming or attending entertainment. This association with transaction portals allows notification server 102 to provide links to transaction portals 122a-122n allowing transactions to be consummated via user device 112. Alternatively, a respective transaction processing mechanism can be hosted by notification server 102 for access via user device 112.

Further still, one or more of data feeds 120a-102n may be operatively connected to content providers having content servers 124a and 124b. As alluded to above, one or more of data feeds 120a-120n may be embodied by content providers, such as studios or media distribution entities. Accordingly, the exhibition and entertainment data received by notification server 102 from data feeds 120a-120n may be associated with media content (for example, full-length movies, movie previews, and the like) provided by the content providers and distributed via content servers 124a and 124b. This media content can be delivered to one or more user devices, such as user device 112, which may be a smartphone, a set-top box, a personal computer, etc. via download or broadcasting of the media content and/or streaming of the media content. In some scenarios where the relevant entertainment is a DVD release of a movie or a concert event, previews of the entertainment can be accessed via content servers 124a and 124b. It should be noted that the entertainment data and the exhibition data can be matched, e.g., by common identification information, so that a resulting exhibition notification can be presented having relevant information for the user. For example, theatrical release dates may differ depending on locale. Thus, an exhibition notification can be tailored to a specific user based, for example, on the user's location that can be ascertained via a user profile or user preferences.

FIGS. 3A-3F illustrate various user interface (UI) aspects of an exhibition date notification application in accordance with various embodiments of the present disclosure.

FIG. 3A illustrates an example user homepage, i.e., User A homepage 302. User A homepage 302 may display, on user device 112, a menu of options that a user may choose to select entertainment of interest to the user, view and control notifications, specify notification preferences, and institute other controls, such as parental controls.

FIG. 3B illustrates an example entertainment selection menu 304. As described previously, a user need not select individual entertainment titles, as is currently performed with conventional notification systems and methods (which require a user accessing a specific webpage, such as a movie theater webpage, in order to select a particular movie for which the user wishes to receive a release date notification). Instead, in accordance with various embodiments of the present disclosure, the user may simply select an entertainment genre or specify a particular entertainment distributor, such as a particular production studio.

FIG. 3C illustrates an example title selection menu 306. Once the user has selected a desired entertainment genre and/or entertainment distributor, the user is presented with relevant entertainments. For example, if the user selects a particular movie production studio, title selection menu 306 will display to the user, all or some predetermined subset of upcoming movie releases commensurate with the movie production studio selection. Notification or alerts may be presented to the user based on the user-selected titles. It should be noted that subsets of upcoming releases may be presented in accordance with additional user preferences, such as user-specified movie genre, rating, or other preference. Moreover, the exhibition date notification application may retrieve user entertainment history or other analytical data that can be leveraged to display only those entertainments that would be of interest to the user.

FIG. 3D illustrates an example notification control menu 308. Notification control menu 308 may present one or more options a user may exercise to control how notifications are presented/displayed/handled. For example, the user may choose to select a style of notification, such as a banner or pop-up style notification. Notification control menu 308 may also present the user with a summary of remaining alerts/notifications, an option to ignore any remaining alerts. Notification control menu 308 may further provide the user with the option to have a purchase option and/or preview/summary presented along with the notification.

FIG. 3E illustrates an example timing menu 310. Timing menu 310 provides the user with options regarding how often and/or when notification regarding an exhibition date should be presented. For example, the user may specify how many days in advance of an exhibition date that the exhibition notification application is to notify the user. The user may further specify particular days of the week during which the user desires to receive notifications.

FIG. 3F illustrates an example notification type menu 312. Notification type menu 312 presents options regarding the type of notification that the user may wish to receive. Notifications can include, but are not limited to text notifications, email notifications, social media application notifications, and user device notifications. For example, the user may wish to receive notifications via text and email only. Additionally, notification type menu 312 can provide the user with the option to turn off notifications.

FIG. 3G illustrates an example parental controls menu 314. Parental controls menu 314 presents one or more options for controlling the type of entertainment for which notifications may be received and/or the type of previews, synopsis, branding information, etc. that may be displayed by the exhibition date notification application. For example, the user can choose to turn parental controls on or off. The user may also choose to lock the parental controls preferences with a pass code. An example of parental controls is the designation of appropriate movie rating, e.g., G, PG, PG-13, R, etc.

FIG. 3H illustrates an example notifications summary menu 316. Notifications summary menu 316 can display, to the user, a summary of entertainment titles, e.g., movies, games, etc., with upcoming release dates. The user can view entertainment titles for which he/she will receive notifications. That is, the user may have previously opted to receive notifications for Title J (see title selection menu 306 of FIG. 3C. Notifications summary menu 316 gives the option for the user to cancel notifications for Title J and add notifications for Title I, in accordance with one scenario.

FIG. 3I illustrates an example notification confirmation screen 318. Notification confirmation screen 318 may be presented to the user, upon the user selecting to receive a notification(s) regarding a particular entertainment title, such as title H. Notification confirmation screen 318 may allow for additional content discovery by allowing the user to select one or more options relating to additional theatrical releases, tickets, trailers, DVD and streaming releases, game release dates, etc. A summary of the entertainment title's movie rating, synopsis, as well as the option to purchase or pre-order the title or preview the title can be presented to the user.

FIG. 3J illustrates an example notification screen or page 320 that may be displayed to a user on user device 112. Notification screen 320 can indicate the date, the appropriate release format, in this case, a DVD release, the entertainment title, as well as the option to preview and/or buy the entertainment title. It should be noted that other information or options may be provided along with the notification. For example, notification screen 320 provides the option to snooze or dismiss the notification.

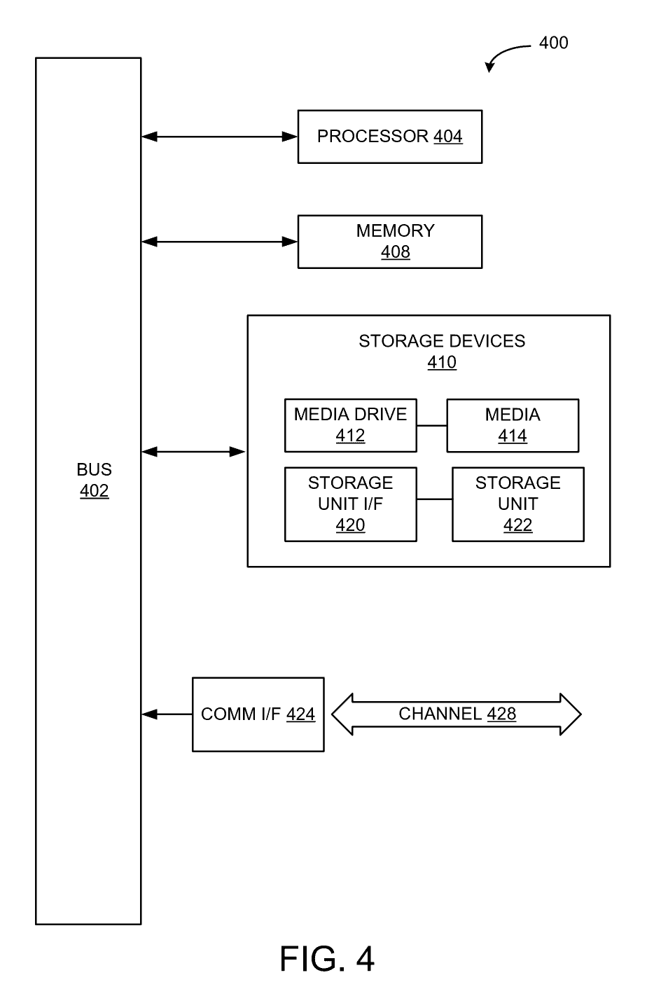

FIG. 4 illustrates an example computing component that may be used to implement various features of the system and methods disclosed herein, such as the aforementioned features and functionality of notification server 102 of FIG. 2, user device 112 of FIG. 1, on which an exhibition notification application may be implemented.

As used herein, the term component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. Even though various features or elements of functionality may be individually described or claimed as separate components, one of ordinary skill in the art will understand that these features and functionality can be shared among one or more common software and hardware elements, and such description shall not require or imply that separate hardware or software components are used to implement such features or functionality.

Where components or components of the application are implemented in whole or in part using software, in one embodiment, these software elements can be implemented to operate with a computing or processing component capable of carrying out the functionality described with respect thereto. One such example computing component is shown in FIG. 4. Various embodiments are described in terms of this example-computing component 400. After reading this description, it will become apparent to a person skilled in the relevant art how to implement the application using other computing components or architectures.

Referring now to FIG. 4, computing component 400 may represent, for example, computing or processing capabilities found within a self-adjusting display, desktop, laptop, notebook, and tablet computers; hand-held computing devices (tablets, PDA's, smart phones, cell phones, palmtops, etc.); workstations or other devices with displays; servers; or any other type of special-purpose or general-purpose computing devices as may be desirable or appropriate for a given application or environment. Computing component 400 might also represent computing capabilities embedded within or otherwise available to a given device. For example, a computing component might be found in other electronic devices such as, for example navigation systems, portable computing devices, and other electronic devices that might include some form of processing capability.

Computing component 400 might include, for example, one or more processors, controllers, control components, or other processing devices, such as a processor 404. Processor 404 might be implemented using a general-purpose or special-purpose processing engine such as, for example, a microprocessor, controller, or other control logic. In the illustrated example, processor 404 is connected to a bus 402, although any communication medium can be used to facilitate interaction with other components of computing component 400 or to communicate externally.

Computing component 400 might also include one or more memory components, simply referred to herein as main memory 408. For example, preferably random access memory (RAM) or other dynamic memory, might be used for storing information and instructions to be executed by processor 404. Main memory 408 might also be used for storing temporary variables or other intermediate information during execution of instructions to be executed by processor 404. Computing component 400 might likewise include a read only memory (“ROM”) or other static storage device coupled to bus 402 for storing static information and instructions for processor 404.

The computing component 400 might also include one or more various forms of information storage mechanism 410, which might include, for example, a media drive 412 and a storage unit interface 420. The media drive 412 might include a drive or other mechanism to support fixed or removable storage media 414. For example, a hard disk drive, a solid state drive, a magnetic tape drive, an optical disk drive, a compact disc (CD) or digital video disc (DVD) drive (R or RW), or other removable or fixed media drive might be provided. Accordingly, storage media 414 might include, for example, a hard disk, an integrated circuit assembly, magnetic tape, cartridge, optical disk, a CD or DVD, or other fixed or removable medium that is read by, written to or accessed by media drive 412. As these examples illustrate, the storage media 414 can include a computer usable storage medium having stored therein computer software or data.

In alternative embodiments, information storage mechanism 410 might include other similar instrumentalities for allowing computer programs or other instructions or data to be loaded into computing component 400. Such instrumentalities might include, for example, a fixed or removable storage unit 422 and an interface 420. Examples of such storage units 422 and interfaces 420 can include a program cartridge and cartridge interface, a removable memory (for example, a flash memory or other removable memory component) and memory slot, a PCMCIA slot and card, and other fixed or removable storage units 422 and interfaces 420 that allow software and data to be transferred from the storage unit 422 to computing component 400.

Computing component 400 might also include a communications interface 424. Communications interface 424 might be used to allow software and data to be transferred between computing component 400 and external devices. Examples of communications interface 424 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 424 might typically be carried on signals, which can be electronic, electromagnetic (which includes optical) or other signals capable of being exchanged by a given communications interface 424. These signals might be provided to communications interface 424 via a channel 428. This channel 428 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 408, storage unit 420, media 414, and channel 428. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 400 to perform features or functions of the present application as discussed herein.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method, comprising:
receiving from a user, an indication of at least one of an entertainment distributor and genre of entertainment; and
transmitting to the user, at least one electronic notification associated with an exhibition of one or more entertainments provided by the entertainment distributor or commensurate with the genre of entertainment.

2. The method of claim 1, further comprising, receiving, from the user, one or more electronic notification parameters comprising at least one of an electronic notification type, an electronic notification style, and timing for the electronic notification.

3. The method of claim 2, wherein the timing for the electronic notification comprises a time period prior to the exhibition of the one or more entertainments.

4. The method of claim 1, further comprising receiving at least one of entertainment data and exhibition data from at least one data feed associated with the one or more entertainments prior to a request from the user to receive the at least one electronic notification or substantially in real-time following the request from the user to receive the at least one electronic notification.

5. The method of claim 4, further comprising matching a common aspect of the entertainment data and the exhibition data such that the at least one electronic notification is tailored to at least one characteristic of the user.

6. The method of claim 1, further comprising presenting at least one option item in conjunction with the at least one electronic notification, the at least one option item comprising an option to preview the one or more entertainments or an option to purchase the rights to consume or attend the exhibition of the one or more entertainments.

7. The method of claim 1, further comprising presenting at least one option item in conjunction with the at least one electronic notification, the at least one option item comprising an option to at least one of preview and purchase additional entertainments.

8. The method of claim 1, wherein the at least one electronic notification comprises a notification indicating an upcoming release date or exhibition date associated with the exhibition of the one or more entertainments.

9. The method of claim 1, further comprising storing the at least one electronic notification and presenting the at least one stored electronic notification in a summarized format.

10. An apparatus, comprising:
a processor; and
a memory having computer code configured to cause the processor to:
receive from a user, an indication of at least one of an entertainment distributor and genre of entertainment; and
transmit to the user, at least one electronic notification associated with an exhibition of one or more entertainments provided by the entertainment distributor or commensurate with the genre of entertainment.

11. The apparatus of claim 10, further comprising a data interface adapted to receive at least one of entertainment data and exhibition data associated with the one or more entertainments, the at least one of the entertainment and exhibition data being received from a data feed.

12. The apparatus of claim 11, wherein the data feed is operatively connected to a transaction portal adapted to provide transaction processing for purchasing at least one of the rights to consume or attend the exhibition of the one or more entertainments.

13. The apparatus of claim 11, wherein the data feed is operatively connected to a content server adapted to provide at least one of the exhibition of the one or more entertainments and a preview of the exhibition of the one or more entertainments.

14. The apparatus of claim 10, wherein the apparatus comprises a notification server communicatively connected to a user device adapted to receive the at least one electronic notification.

15. The apparatus of claim 10, wherein the computer code comprises an exhibition notification application configured to cause the processor to display a user interface adapted to receive one or more user preferences regarding presentation of the at least one electronic notification and present the at least one electronic notification to the user in accordance with the one or more user preferences.

16. The apparatus of claim 15, wherein the exhibition notification application is configured to further cause the processor to display at least one option item to the user in conjunction with the at least one electronic notification, the at least one option item comprising an option to preview the one or more entertainments or an option to purchase the rights to consume or attend the exhibition of the one or more entertainments.

17. The apparatus of claim 16, wherein the exhibition notification application is configured to further cause the processor to receive at least one of entertainment data and exhibition data associated with the one or more entertainments from a notification server, the at least one electronic notification being derived from the at least one of entertainment data and exhibition data.

18. The apparatus of claim 17, wherein the apparatus comprises a user device communicatively coupled to a notification server via a network, and wherein the notification server receives the at least one of entertainment data and exhibition data from one or more data feeds associated with the entertainment distributor.

19. The apparatus of claim 18, wherein the user device is communicatively coupled to at least one content server via the network, and wherein the preview of the one or more entertainments is obtained via the at least one content server.

20. The apparatus of claim 19, wherein the user device is communicatively coupled to at least one transaction portal via the network, and wherein the option to purchase the rights to consume or attend the exhibition of the one or more entertainments is effectuated via the at least one transaction portal.

21. A computer-implemented method, comprising:
receiving information indicative of at least one of a media content distributor and genre of media content;
retrieving information regarding at least one release date associated with a media content provided by the media content distributor or commensurate with the indicated genre of media content;
presenting, to a user, an electronic alert informing the user of the at least one release date based upon a predetermined amount of time preceding the at least one release date or reminding the user that the at least one release date has passed.
